(19) United States
(12) Patent Application Publication
(10) Pub. No.: US 2010/0008485 A1
(43) Pub. Date: Jan. 14, 2010

(54) DEVICE FOR SCREENING OUT NON-ORIGINAL CALLING NUMBERS

(76) Inventor: Chun-Sheng HSU, Taipei City (TW)

Correspondence Address: Muncy, Geissler, Olds & Lowe, PLLC, P.O. BOX 1364, FAIRFAX, VA, 22038-1364, US

(21) Appl. No.: 12/491,747

(22) Filed: Jun. 25, 2009

(30) Foreign Application Priority Data
Jul. 9, 2008 (CN) 200820072101.X

(51) Int. Cl. H04M 15/06

(52) U.S. Cl. 379/142.05; 379/142.04

(57) ABSTRACT

A device for screening out non-original calling numbers includes at least one teleport and a called party operator which are interconnected by a telecommunication network. The teleport has a calling module which generates a calling signal to carry out a talk; the calling signal is transmitted to the telecommunication network and is transmitted through the telecommunication network to a toll-free telephone module of the called party operator. The calling signal is also transmitted to a screening device to detect whether the calling signal is the original calling number and to screen out the non-original calling number. Therefore, the called party operator can effectively screen out the non-original calling number used by the teleport, assure using the original calling number to activate, deactivate, authorize or access data of a service unit, and prevent from resulting in infringement and loss of rights and money to people.

### BACKGROUND OF THE INVENTION

a) Field of the Invention

The present invention relates to a device for screening out calling numbers and more particularly to a device for screening out non-original calling numbers, wherein when a toll-free telephone module is used by a called party operator, a calling number used by a teleport can be determined whether the calling number is the original calling number and is screened out.

b) Description of the Prior Art

In a society where technologies are progressed continuously, a communication technology plays a rather important role and is renovated continuously, such that communication between people can be more convenient and can better comply with economical benefits. The communication operators can be divided primarily into a first kind of telecommunication operator and a second kind of telecommunication operator, wherein the first kind of telecommunication operator belongs primarily to the operator who performs network infrastructure construction, such as setting up a base station, laying out a network or implementing a telephone line; whereas the second kind of telecommunication operator rents accessory functions of the first kind of telecommunication operator.

It is rather popular to use a toll-free telephone in the existing communication technology, such as 080 or 0809, wherein when a called party operator applies for the toll-free telephone, the called party operator is provided with a toll-free telephone module which is accompanied with a designated local telephone number, such that when a teleport calls to the toll-free telephone module, a call charge is paid by the called party operator. In addition, as the call charge is paid by the called party operator, the toll-free telephone module can only receive talks of the original callings.

On the other hand, when an existing ordinary telephone module receives callings of a teleport, calling numbers of the teleport can be displayed, yet a function for authenticating the calling numbers is not available. As a result, when the teleport is not an original calling party, such as that the calling party is an international calling, the teleport is a network phone, the teleport is a non-original calling party, a calling number is changed illegally or a talk is conducted through an intermediate operator for an incoming call of a wholesale company, the ordinary telephone module used by the called party operator cannot carry out screening. Moreover, when the ordinary telephone module is used by the called party operator to perform a variety of activation, deactivation and authorization of permissions and services, such as a permission of use, an electromagnetic switch, a money service or an online credit card payment, it is unable to effectively determine whether the calling party is the original calling number.

Furthermore, as the ordinary telephone module cannot screen out the calling numbers, if unworthy people create by themselves the calling numbers with same identification codes and use these calling numbers to perform the activation, deactivation and authorization of permissions and services, then the telephone module will continue to carry out these operations, thereby resulting in infringement and loss of rights and money to many people.

### SUMMARY OF THE INVENTION

The primary object of the present invention is to provide a device for screening out non-original calling numbers, wherein a called party operator is provided with a toll-free telephone module which is configured as a toll-free telephone and is connected with a telecommunication network signal at a same time, the telecommunication network transmits a calling signal of a teleport to the toll-free telephone module, the calling signal received by the toll-free telephone module is detected whether the calling number is the original calling number by a detection module of a screening device, and when the detection module has detected that the calling number is the original calling number, the calling signal can be transmitted to a local telephone module which is owned by the called party operator. By the aforementioned technologies, an issue of the prior art that the calling numbers cannot be screened out can be solved, thereby achieving the practical progressiveness that the calling number used by the teleport can be determined whether the calling number is the original calling number and is screened out.

Another object of the present invention is to provide a device for screening out non-original calling numbers, wherein the screening device can be connected with a service module through the calling signal, the service module is provided with at least one service unit which uses the calling signal to activate, deactivate and authorize permissions and services, and the activation, deactivation, authorization or data accessing of the service unit are carried out if the detection module of the screening device has detected that the calling signal is the original calling number. By the aforementioned technologies, an issue that the conventional ordinary telephone module cannot screen out the calling numbers, so that the activation, deactivation and authorization of permissions and services can be totally performed even the calling number is not the original calling number, is solved, thereby achieving the practical progressiveness that the calling number used by the teleport can be determined whether the calling number is the original calling number, in order to perform the activation, deactivation, authorization or data accessing of the service unit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

FIG. 2 shows a first schematic view of a preferred embodiment of the present invention.

FIG. 3 shows a second schematic view of a preferred embodiment of the present invention.

FIG. 4 shows a third schematic view of a preferred embodiment of the present invention.

### DETAILED DESCRIPTION OF THE PREFERRED EMBODIMENTS

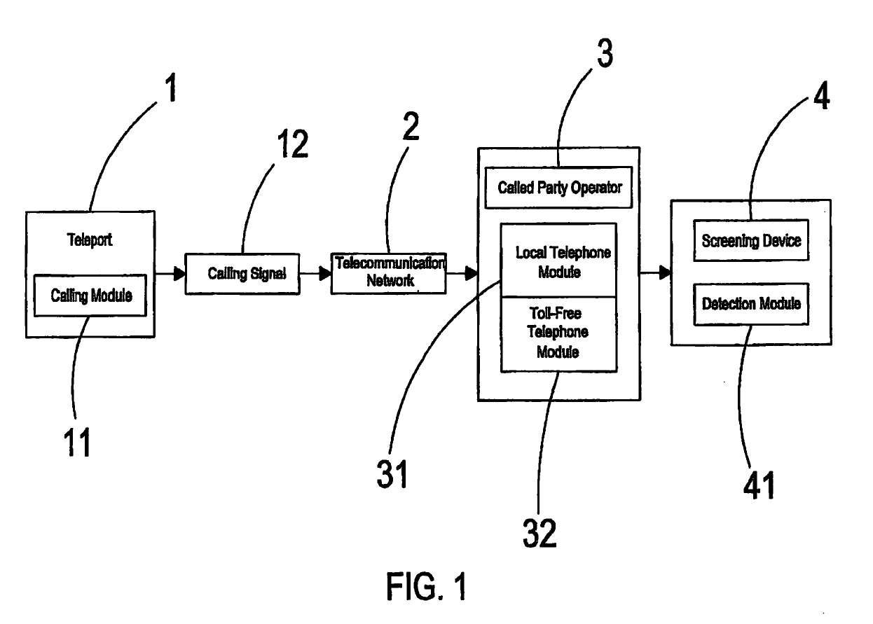

Referring to FIG. 1, it shows a block diagram of a preferred embodiment of the present invention. As shown in the drawing, a device for screening out non-original calling numbers, of the present invention, comprises at least one teleport 1, a telecommunication network 2 and a called party operator 3, wherein the teleport 1 is connected with the called party operator 3 by the telecommunication network 2.

The teleport 1 is provided with a calling module 11 which can generate a calling signal 12 to carry out talking, and the calling signal 12 is transmitted to the telecommunication network 2.

The called party operator 3 is provided with a local telephone module 31 which can receive the calling signal 12 and a toll-free telephone module 32 which can be configured as a toll-free telephone. In addition, the called party operator 3 is also connected to a screening device 4 through the calling signal 12.

The local telephone module 31 and the toll-free telephone module 32 are interconnected with the telecommunication network 2, and can receive the calling signal 12 generated by the calling module 11.

The screening device 4 receives and detects the calling signal 12 of the teleport 1 using the telecommunication network 2, and is provided with a detection module 41 to detect whether the calling signal 12 of the teleport 1 is the original calling number.

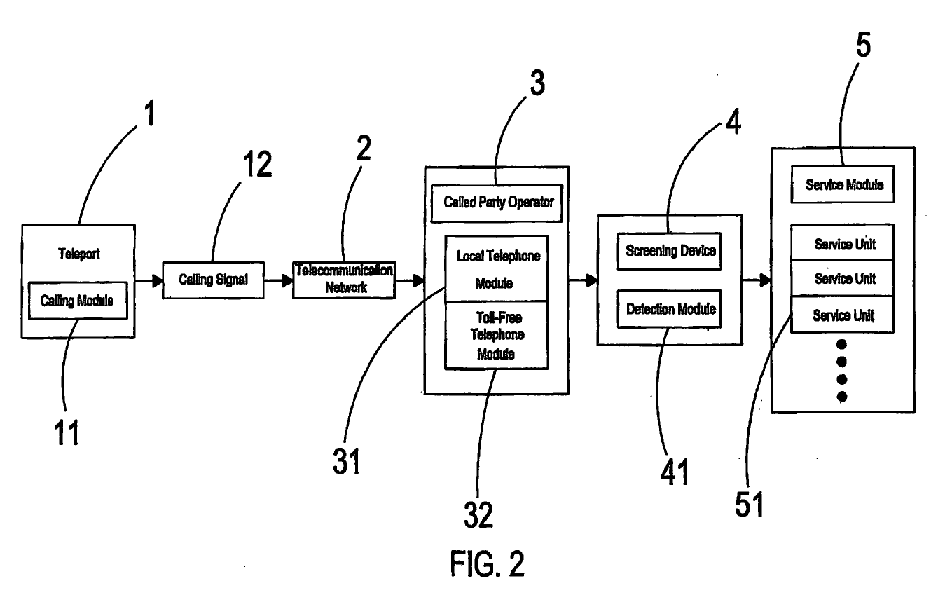

Referring to FIG. 2, it shows a first schematic view of a preferred embodiment of the present invention. As shown in the drawing, the called party operator 3 can be provided with the toll-free telephone module 32 and the screening device 4, the toll-free telephone module 32 is accompanied with the local telephone module 31, and when the teleport 1 is calling whereas the calling module 11 generates the calling signal 12, the calling signal 12 is transmitted to the called party operator 3 through the telecommunication network 2. On the other hand, the toll-free telephone module 32 of the called party operator 3 will receive the calling signal 12 and transmit the calling signal 12 to the screening device 4 to screen out the number, and the detection module 41 will detect the calling module 11 which generates the calling signal 12, in order to determine whether the calling module 11 is the original calling number. If the detection module 41 has detected that the calling module 11 is not the original calling number, the calling signal 12 will stop being generated. In addition, the calling signal 12 will be screened out through the screening device 4 and at a same time, will not be transmitted to the local telephone module 31 of the called party operator 3. The non-original calling number can be generated by a non-local caller, an international caller, a non-local caller of a network phone, a calling number which is changed illegally or an incoming call of a wholesale company. On the contrary, when the detection module 41 has detected that the calling module 11 is the original calling number, the calling signal 12 can be transmitted to the local telephone module 31 and the toll-free telephone module 32 of the called party operator 3, allowing the teleport 1 to conduct a toll-free telephone talk.

A service module 5 includes at least one service unit 51 which uses the calling signal 12 to activate, deactivate and authorize permissions and services, and the service unit 51 can include accessing a subsequent data, activating or deactivating a data downloading service, data protection, activating or deactivating a shopping permission, a permission to access a game data, activating or deactivating a permission to use a network, activating or deactivating a permission to log on to a web site, activating or deactivating an electromagnetic switch, authorizing or aborting a money service. When the detection module 41 has detected that the calling module 11 is the original calling number, the teleport 1 can carry out functions of a toll-free telephone and functions of the service unit 51 in the service module 5.

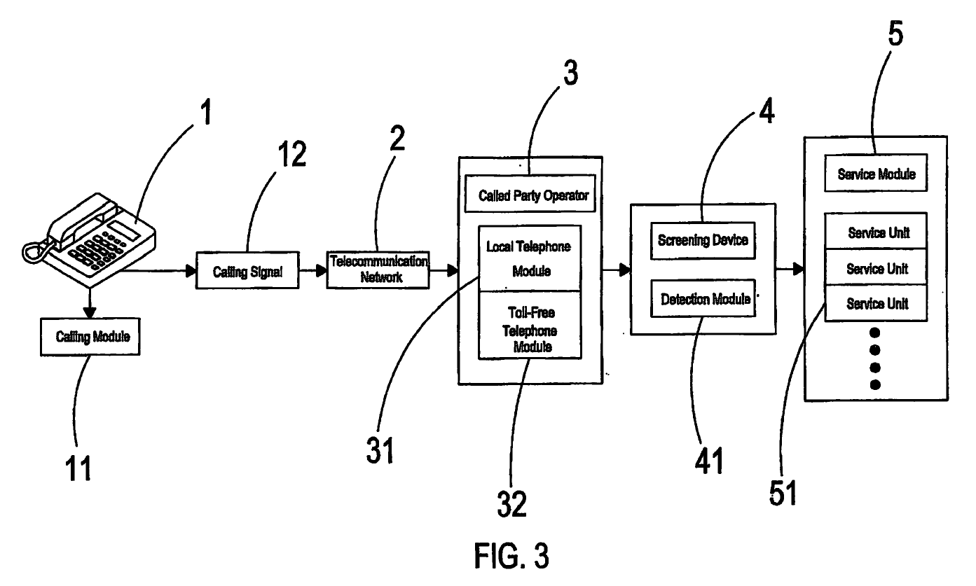

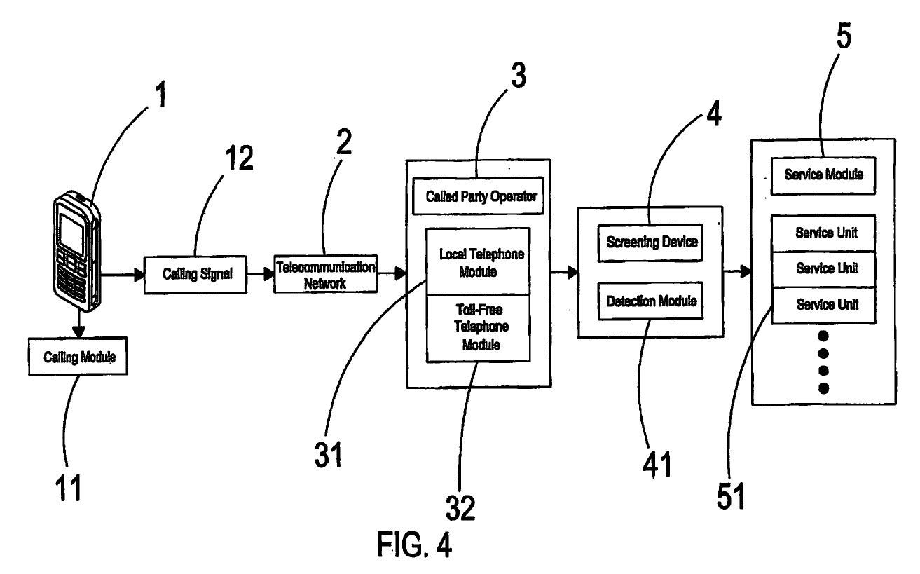

Referring to FIG. 3 and FIG. 4, it shows a second and a third schematic view of a preferred embodiment of the present invention. As shown in the drawings, when the teleport 1 is a local telephone and is calling, the calling signal 12 can be generated and transmitted through the telecommunication network 2 to the toll-free telephone module 32 of the called party operator 3. Whereas, when the toll-free telephone module 32 receives the calling signal 12, the calling signal 12 will be transmitted to the screening device 4 for screening out the number, and the detection module 41 will detect the calling module 11 which generates the calling signal 12. If the calling signal 12 is not the original calling number, then the calling signal 12 will not be transmitted to the local telephone module 31 of the called party operator 3. On the contrary, if the calling signal 12 is the original calling number, then the calling signal 12 can be transmitted by the local telephone module 31 to a telephone host which belongs to the local telephone module 31, and the service unit 51 of the service module 5 can operate, so as to effectively screen out the non-original calling number of the teleport 1 and prevent from resulting in infringement and loss of rights and money to people.

On the other hand, when the teleport 1 is a mobile phone and is calling, the calling signal 12 can be generated and transmitted through the telecommunication network 2 to the local telephone module 31 of the called party operator 3. Whereas, when the local telephone module 31 receives the calling signal 12, the calling signal 12 will be transmitted to the screening device 4 for screening out the number, and the detection module 41 will detect the calling module 11 which generates the calling signal 12. If the calling signal 12 is not the original calling number, then the calling signal 12 will not be transmitted to the local telephone module 31 of the called party operator 3. On the contrary, if the calling signal 12 is the original calling number, then the calling signal 12 can be transmitted by the local telephone module 31 to a telephone host which belongs to the local telephone module 31, and the service unit 51 of the service module 5 can operate, so as to effectively screen out the non-original calling number of the teleport 1 and prevent from resulting in infringement and loss of rights and money to people.

Accordingly, referring to all the drawings, the present invention is actually provided with following advantages when compared with the prior art:
1. The called party operator 3 is provided with the toll-free telephone module 32, the telecommunication network 2 can transmit the calling signal 12 of the teleport 1 to the toll-free telephone module 32, and the calling signal 12 that is received by the toll-free telephone module 32 is detected through the detection module 41 of the screening device 4 to determine whether the calling signal 12 is the original calling number. When the detection module 41 has detected that the calling signal 12 is the original calling number, the calling signal 12 can be transmitted to the local telephone module 31 that is owned by the called party operator 3. On the contrary, if the calling signal 12 is not the original calling number, then the calling signal 12 will not be transmitted to the local telephone module 31 of the called party operator 3, so as to effectively screen out the non-original calling number of the teleport 1.
2. The screening device 4 can be connected with the service module 5 through the calling signal 12, the service module 5 is provided with at least one service unit 51 which uses the calling signal 12 to activate, deactivate and authorize permissions and services, and the activation, deactivation, authorization or data accessing of the service unit 51 is dependent upon whether the detection module 41 of the screening device 4 detects that the calling signal 12 is the original calling number. When the detection module 41 has detected that the calling signal 12 is the original calling number, the calling signal 12 can be transmitted to the local telephone module 31 that is owned by the called party operator 3. On the contrary, if the calling signal 12 is not the original calling number, then the calling signal 12 will not be transmitted to the local telephone module 31 of the called party operator 3, so as to effectively screen out the non-original calling number of the teleport 1 and prevent from resulting in infringement and loss of rights and money to people.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A device for screening out non-original calling numbers comprising at least one teleport and a called party operator which are interconnected by a telecommunication network, wherein the teleport is provided with a calling module which generates a calling signal and transmits the calling signal to the telecommunication network; and the called party operator is provided with a toll-free telephone module which is configured as a toll-free telephone and is connected with the telecommunication network, and the telecommunication network transmits the calling signal of the calling module to the toll-free telephone module, with the called party operator having a screening device which is provided with a detection module to detect whether the calling signal of the teleport is the original calling number.

2. The device for screening out non-original calling numbers according to claim 1, wherein the screening device is connected with a service module through the calling signal and the service module is provided with at least one service unit which uses the calling signal to activate, deactivate and authorize permissions and services.

3. The device for screening out non-original calling numbers according to claim 2, wherein the service unit includes accessing a subsequent data, data downloading, data protection, shopping, gaming, a permission to use a web site, a permission to log on to a web site, an electromagnetic switch or a money service.

4. The device for screening out non-original calling numbers according to claim 1, wherein the called party operator is further provided with a local telephone module which is accompanied by the toll-free telephone module, such that when the teleport is a local telephone, the calling signal of the teleport is detected by the detection module of the screening device to determine whether the calling signal is the original calling number.

5. The device for screening out non-original calling numbers according to claim 4, wherein the called party operator is provided with the toll-free telephone module, and when the teleport is a mobile phone, the teleport generates a calling signal to the local telephone module and the calling signal of the teleport is detected by the detection module of the screening device to determine whether the calling signal is the original calling number.
